(19) United States
(12) Patent Application Publication
(10) Pub. No.: US 2009/0000499 A1
(43) Pub. Date: Jan. 1, 2009

(54) Device and Method for Chambered Doctor Blade

(75) Inventors: Ake Boose, Lidingo (SE); Fredrik Irlen, Alta (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Ake-Boose International AB, Lidingo (SE)

(21) Appl. No.: 11/579,719

(22) PCT Filed: May 3, 2005
(86) PCT No.: PCT/SE2005/000639

§ 371 Date: Aug. 25, 2008

(30) Foreign Application Priority Data
May 5, 2004 (SE) 0401168-0

(51) Int. Cl. B41F 1/46

(52) U.S. Cl. 101/363

(57) ABSTRACT

Apparatus for applying a liquid medium such as a printing medium to a rotatable cylinder is disclosed including a chambered doctor blade with an elongated frame, a pair of doctor blades in wiping engagement with the surface of the rotatable cylinder, a seal disposed axially with respect to the cylinder including first and second seals, with the elongated frame, the doctor blades, the seal and the surface of the cylinder forming an elongated chamber containing the liquid medium, and at least one drainage channel including an inlet in the space between the two seals for diverting leaking medium from the space. Also disclosed is such apparatus which includes at least one spray nozzle within the elongated chamber for cleaning the chamber, the nozzle being movable between a number of outlet directions. A method for sealing the chambered doctor blade is also disclosed.

### FIELD OF THE INVENTION

The present invention relates to a device in a chambered doctor blade for use in a printing unit. The present invention also relates to a method for end sealing a chambered doctor blade.

### BACKGROUND OF THE INVENTION

A chambered doctor blade is preferably used as a device for inking a screen roller in a flexoprinting unit.

A modern chambered doctor blade generally comprises an elongated frame which, along both of its parallel long sides holds a doctor blade parallel to the long side, and at its ends contains an arrangement functioning as an end seal.

The doctor blades are, as seen in cross section arranged so that their free longitudinal shanks incline inwardly against each other, at a certain distance from each other, so that when the frame of the chamber is arranged parallel to the axis of the screen roller and is moved towards the roller, both of the doctor blades will rest against the envelope surface of the screen roller along its entire length.

The doctor blades are generally longer than the envelope surface of the screen roller, such that they extend slightly outside of the envelope surface on both sides thereof.

In this manner, the frame of the chambered doctor blade forms, along with its parallel fixed doctor blades, an elongated chamber against the envelope surface of the screen roller. The chamber is parallel to the axis of the screen roller and is delimited at its ends by an end seal of compressible material, or by a construction which provides a similar function, and which fills and seals the cross section of the elongated chamber at the ends of the chamber. The end seal arrangement consequently seals internally against the frame of the chamber and its doctor blades and against the envelope surface of the screen roller between the doctor blades. An end seal may typically require a length of 10 to 30 mm of the envelope surface.

When the chambered doctor blade bears upon the surface of the rotating screen roller and is entirely or partially filled with printing ink, the envelope surface of the screen roller is continuously supplied with fresh ink through the opening, which is defined by doctor blades and end seals.

The doctor blades are constituted by a thin band-shaped resilient material, for example, spring steel or plastic. The doctor blades often have an angle of application against the envelope surface of the screen roller of approximately 35 degrees counting from the outside of the doctor blades against the tangent of the roller at the contact point.

When the chamber is pressed against the roller the doctor blades will thus be resiliently pressed inwardly against the chamber, whereby the end seals have to be elastically deformable and follow the movements of the doctor blade, in order to not loose its sealing ability.

End seals are often built up of molded or form died materials, which may be thin, flexible, simple or multiple layered or thicker, or foamed with gas in order to provide resilient properties to the material. Fibrous materials are also used in a portion of the entire end seal, and the material may be impregnated with solvents.

Most end seals leak. Certain end seals may be completely tight as long as they are new and soaked with solvent and sealing agent, but generally start to leak after a certain period of operation of the printing unit. Many printing offices experience this leakage as disturbing, as it gives rise to loss of ink and unnecessary cleaning of details in the printing unit.

The leaking flow of ink is often small, but it is hard to deal with, precisely because of the flow being so small. The ink often manages to dry in the collecting device, which may be constituted by an end housing or a groove, before the ink is somehow lead further back to the ink vessel in the printing unit. The ink may also easily be soiled by dust particles in the air on its way to the ink vessel, making it unusable for further use as a printing ink.

Thin solvent drying inks have, among other things, the characterising property of drying when subjected to blowing air.

In a printing unit air currents often occur from rotating rollers and running webs. At the ends of the screen roller an air current occurs which is generated by the end cover of the rotating roller, which centrifuges the air closest to this surface. New air is supplied from the roll neck.

A chambered doctor blade is generally somewhat longer than the screen roller being inked by same. The chambered doctor blade generally has its end seals placed close to the ends of the roller. Therefore, the end seals are subjected to a continuous air current, which entirely or partially dries the leaking ink immediately outside the end seals.

If dried up ink is successively built up outside of the end seals, there is a considerable risk that their function will successively deteriorate, so that the end seals start to release ink over the ends of the screen roller. This then results in this ink being centrifuged/thrown out of the ink unit, with accompanying negative consequences in the form of ink loss and splashing of the printing unit with expensive ink.

Each time the printing ink in a printing unit is to be changed to a new ink, in order to carry out a new printing task, all of the surfaces inked from the first ink must be cleaned. A change of ink made from a darker to a lighter ink is expressed as a “critical” change of ink. By this it is meant that even a small amount of ink of the first ink easily contaminates the other ink, such that it is no longer possible to print the shade of color which is intended to be printed. In this manner, the quality of the finished print is affected in a negative way or in a totally devastating way. If the ink is too contaminated by the first ink, and this is not established until the new printing task is running, the second ink must generally be changed by a fresh new ink, with accompanying costs in the form of loss of ink and loss of production time in the printing unit.

In modern printing units, utilizing printing smaller editions with many changes of ink per day, some kind of automatic washing system must be provided in order to simplify and shorten each change of ink.

A variant is to use spray nozzles. Regarding spray nozzles, there are a great number of arrangements of the like used in chambered doctor blades for automatic cleaning. The spray nozzles are fixedly mounted and immobile and often of the flat jet type. Spray nozzles of the cone type, filled or hollow, also exist. Due to the elongated, narrow space, bound by the frame of the chamber, its doctors and the surface of the screen roller between the doctor blades, which need to be rinsed out/cleaned, a greater amount of spray nozzles need to be mounted.

Printing ink ending up outside of end seals and doctor blades, or on the outside thereof, is very hard to reach with fully automatic or semiautomatic cleaning systems which operate when the chambered doctor blade is in its operating position against the screen roller in the printing unit. The more ink ending up outside the chambered doctor blade, and the more dried up this ink is, the more extensive the manual cleaning needs to be made in order to facilitate a critical change of ink. Ink ending up on surfaces normally not subjected to printing ink may of course be allowed to remain, if only this ink will not contaminate upcoming inks. Such ink may instead be removed by more extensive cleaning operations.

One object of the present invention is to minimize manual cleaning of a chambered doctor blade in a flexoprinting unit.

Another object of the present invention is to substantially eliminate the above mentioned end sealing problems of a chambered doctor blade.

### SUMMARY OF THE INVENTION

These and other objects have now been realized by the discovery of apparatus for applying a liquid medium to a rotatable cylinder comprising a chambered doctor blade including an elongated frame disposed parallel to the outer surface of the rotatable cylinder, a pair of doctor blades operatively arranged parallel to the rotatable cylinder and parallel to and separated from each other for wiping engagement with the surface of the rotatable cylinder, sealing means disposed axially with respect to the rotatable cylinder and comprising a first sealing member and a second sealing member spaced apart from the first sealing member to form a space therebetween, the elongated frame, the pair of doctor blades, the sealing means, and the surface of the rotatable cylinder forming an elongated chamber containing the liquid medium for application to the surface of the rotatable cylinder, and at least one drainage channel including an inlet disposed in the space between the first and second sealing members for diverting leaking liquid medium from the space. Preferably, the liquid medium is a liquid such as an ink, such as a printing ink, lacquer, adhesives, or the like.

In accordance with one embodiment of the apparatus of the present invention, the inlet of the at least one drainage channel is disposed in a lower portion of the elongated frame.

In accordance with another embodiment of the apparatus of the present invention, the apparatus includes a pump connected to the at least one drainage channel for pumping out the liquid medium.

In accordance with another embodiment of the apparatus of the present invention, the at least one drainage channel diverts the liquid medium into a tank.

In accordance with another embodiment of the apparatus of the present invention, the apparatus includes at least one spray nozzle disposed above the inlet of the at least one drainage channel for intermittently supplying solvent thereto for maintaining drainage and preventing drying of the liquid medium. Preferably, the at least one spray nozzle is disposed for cleaning the elongated chamber. In another embodiment, the at least one spray nozzle is movable between a plurality of outlet directions. In yet another embodiment, the at least one spray nozzle is rotatable about its axis.

In accordance with another embodiment of the apparatus of the present invention, the sealing means comprises first sealing means, and the apparatus includes second sealing means including a third sealing member and a fourth sealing member spaced apart from the third sealing member for forming a second space therebetween.

In accordance with another embodiment of the apparatus of the present invention, the apparatus includes a plurality of the sealing means provided in the axial direction of the rotatable cylinder.

In accordance with the present invention, these and other objects have also been realized by the discovery of apparatus for supplying a liquid medium to a rotatable cylinder comprising a chambered doctor blade including an elongated frame disposed parallel to the outer surface of the rotatable cylinder, a pair of doctor blades operably arranged parallel to the rotatable cylinder and parallel to and separated from each other for wiping engagement with the rotatable cylinder, sealing means disposed axially with respect to the rotatable cylinder, the elongated frame, the pair of doctor blades, the sealing means, and the surface of the rotatable cylinder defining an elongated chamber containing the liquid medium for application to the surface of the rotatable cylinder, and at least one spray nozzle disposed within the elongated chamber for cleaning the elongated chamber, the at least one spray nozzle being movable between a plurality of outlet directions. Preferably, the at least one spray nozzle is rotatable about its axis.

In accordance with one embodiment of the apparatus of the present invention, the sealing means comprises a first sealing member and a second sealing member spaced apart from the first sealing member to form a space therebetween. Preferably, the apparatus includes at least one drainage channel including an inlet disposed in the space between the first and second sealing members for diverting leaking liquid medium from the space. In a preferred embodiment, the inlet of the at least one drainage channel is disposed in a lower portion of the elongated frame. In another embodiment, the apparatus includes a pump connected to the at least one drainage channel for pumping out the liquid medium. In the preferred embodiment, the at least one drainage channel diverts the liquid medium into a tank.

In accordance with another embodiment of the apparatus of the present invention, the at least one spray nozzle is disposed above the inlet of the at least one drainage channel for supplying solvent into the elongated space for maintaining drainage and preventing drying of the liquid medium.

In accordance with another embodiment of the apparatus of the present invention, the sealing means comprises first sealing means, and including second sealing means including a third sealing member and a fourth sealing member spaced apart from the third sealing member to form a second space therebetween.

In accordance with another embodiment of the apparatus of the present invention, the apparatus includes a plurality of the sealing means provided in the axial direction of the rotatable cylinder.

In accordance with the present invention, a method has also been provided for sealing a chambered doctor blade for use in applying a liquid medium to a rotatable cylinder wherein the chambered doctor blade includes an elongated frame disposed parallel to the outer surface of the rotatable cylinder, a pair of doctor blades operatively arranged parallel to the rotatable cylinder and parallel to and separated from each other for wiping engagement with the rotatable cylinder, and wherein the elongated frame, the pair of doctor blades, the sealing means, and the surface of the rotatable cylinder define an elongated chamber containing the liquid medium for application to the rotatable cylinder, the method comprising draining the liquid medium from the elongated chamber through the sealing means. In a preferred embodiment, the method includes intermittently supplying solvent into the elongated chamber for preventing drying of the liquid medium and/or dissolving dried liquid medium.

In accordance with one embodiment of the method of the present invention, the method includes pumping liquid medium from the elongated chamber.

In accordance with another embodiment of the method of the present invention, the method includes diverting the liquid medium to a tank.

These and other objects, apparent from the following description, are achieved by a device in a chambered doctor blade, and a method for sealing a chambered doctor blade.

The device according to the present invention is characterised by sealing means comprising a first and a second part forming a space therebetween extending in the axial direction of the cylinder in which an inlet of at least one drainage channel is provided for diverting leaking medium from the space, and several inconveniences with prior art are now overcome. The drainage channel results in the ink being diverted through the closed channel such that the risk of ink or the like accumulating outside of the first sealing part is substantially reduced. The double end seal arrangement hereof results in the advantage that the first sealing part and its leaking ink is protected against undesired air currents, such that the risk of the ink drying is reduced. An additional advantage is that it becomes easier to take care of the leaking flow of ink as the ink does not manage to dry, for example, before it manages to leak back to the ink vessel in the printing unit. An additional advantage is that on its way to the ink vessel the ink is not soiled by dust particles in the air which would make it unusable for further use as a printing ink. The drainage channel consequently results in substantially improved sealing and reduces the need for manual cleaning.

Preferably, the device of the present invention has the further advantage of the inlet of the drainage channel being arranged at the bottom of the chambered doctor blade so that the medium may flow gravimetrically through the closed channel.

Preferably, the device of the present invention has the advantage, with a pumping device being connected to the drainage channel for pumping away leaking medium through any of the sealing parts that the medium may then be led to a desired location, independent of its spatial position, such as to the ink vessel in the printing unit or the like.

Preferably, the device of the present invention has the further advantage, with the at least one drainage channel debouching into a tank for taking care of a diverted medium, that the medium may then be reused such that loss of ink is substantially eliminated.

Preferably, the device of the present invention has the further advantage, with a spray nozzle for supplying solvent or the like above the inlet of the drainage channel, that it is thus guaranteed that no leaking ink is dried and that the ink is diluted and thereby becomes more thinly liquid and may more easily flow through the drainage channel. An additional advantage is that the spray nozzles may be used for effectively rinsing the space between the first and second seals during cleaning of the chamber in the printing unit. The portion of the screen roller running between the first and second seals is also intended to be rinsed/washed by solvent from these spray nozzles.

Preferably, the device of the present invention has the advantage, with arranging at least one spray nozzle for cleaning of chamber, that unnecessary cleaning of details in the printing unit is minimized. An additional advantage is that manual cleaning by changing the ink is minimized.

Preferably, the device of the present invention has the further advantage, with a spray nozzle being movable with varying outlet directions, that such a spray nozzle sprays a much larger area or a much larger section of the chambered doctor blade, whereby a considerably lower number of spray nozzles may be used with the same effect as several immobile spray nozzles. Less spray nozzles means less details to maintain, simpler installation with fewer holes in the frame of the chamber, and less hoses to draw and connect to a second pump supplying these with washing liquid.

Preferably, the device of the present invention has the further advantage that the roller may be inked with several ink colors at the same time. This is facilitated since the sealing means according to the present invention is completely tight.

Preferably, the device of the present invention has the further advantage that the roller may be provided with inking of different widths. This is facilitated since the sealing means according to the present invention is completely tight.

As the device according to the present invention comprises spray nozzles which are movable with varying outlet directions, such a spray nozzle thus sprays a much larger area or a much larger section of the chambered doctor blade, whereby a considerably lower number of spray nozzles may be used with the same effect as several immobile spray nozzles. Less spray nozzles means less details to maintain, simpler installation with fewer holes in the frame of the chamber and less hoses to draw and connect to a second pump supplying them with washing liquid. Consequently the need for manual cleaning is reduced.

Preferably, the device of the present invention has the further advantage that the first sealing part and its leaking ink are protected against undesired air currents, such that the risk of the ink drying is reduced.

Preferably, the device of the present invention has the further comprises apparatus such that the drainage channel results in the ink being diverted through the closed channel, such that the risk of ink or the like accumulating outside of the first sealing part is substantially reduced. An additional advantage is that it becomes easier to take care of the leaking flow of ink as the ink does not manage to dry, for example, before it manages to be led back to the ink vessel in the printing unit. An additional advantage is that the ink, on its way to the ink vessel, is not soiled by dust particles in the air, which makes it unusable for further use as a printing ink. The drainage channel consequently results in a substantially improved sealing and reduces the need for manual cleaning.

Preferably, the device of the present invention has the further advantage that the ink or the like may flow gravimetrically through the closed channel.

Preferably, the device of the present invention has the further advantage that the ink or the like may be led to a desired location, independent of spatial position, such as to the ink vessel in the printing unit or the like.

Preferably, the device of the present invention has the further advantage that the ink or the like then may be reused, such that loss of ink is substantially eliminated.

Preferably, the device of the present invention has the advantage that it is guaranteed that no leaking ink is dried and that the ink is diluted and thereby becomes more thinly liquid and may more easily flow through the drainage channel. An additional advantage is that the spray nozzles may be used to effectively rinse the space between the first and second seals, during cleaning of the chamber in the printing unit. The portion of the screen roller running between the first and second seals is also intended to be rinsed/washed by solvent from these spray nozzles.

Preferably, the device of the present invention has the further advantage that the roller may be inked with several ink colors at the same time. This is facilitated since the sealing means according to the present invention is completely tight.

Preferably, the device of the present invention has the further advantage that the roller may be provided with inking of different widths. This is facilitated since the sealing means according to the invention is completely tight.

By means of the method according to the present invention in which drainage of leaking ink through the first sealing and through a closed drainage channel having its inlet between a second and a first part of a sealing means, the risk of ink or the like accumulating outside of the first sealing part is substantially reduced. An additional advantage is that it becomes easier to take care of the leaking flow of ink as the ink does not manage to dry, for example, before it manages to be led back to the ink vessel in the printing unit. An additional advantage is that the ink, on its way to the ink vessel, is not soiled by dust particles in the air which makes it unusable for further use as a printing ink. The drainage channel consequently results in a substantially improved sealing and reduces the need for manual cleaning.

Preferably, the device of the present invention has the further advantage that it is guaranteed that no leaking ink is dried and that the ink is diluted and thereby becomes more thinly liquid and may more easily flow through the drainage channel. An additional advantage is that the space between the first and second seals is also cleaned.

Preferably, the device of the present invention has the further advantage that the ink may be led to a desired location, independent of its spatial position, such as to the ink vessel in the printing unit or the like.

Preferably, the device of the present invention has the further advantage that the ink or the like then may be reused such that loss of ink is substantially eliminated.

### BRIEF DESCRIPTION OF THE DRAWINGS

A better understanding of the present invention will be had with reference to the following detailed description when read in conjunction with the accompanying drawings, wherein like reference characters refer to like parts throughout the several views, and in which:

FIG. 1a is a side, perspective, exploded view of a sealing arrangement according to a preferred embodiment of the present invention;

FIG. 1b is a side, elevational view of the sealing arrangement shown in FIG. 1a;

FIG. 1c is a side, perspective view of the sealing arrangement shown in FIG. 1a, in an assembled state;

FIG. 2 is a side, partially schematic view of a chambered doctor blade according to a preferred embodiment of the present invention;

FIG. 3 is a side, perspective view of the chambered doctor blade shown in FIG. 2, viewed from the side of the roller;

FIG. 4a is a top, partial, elevational view of a portion of the chambered doctor blade shown in FIG. 2, viewed obliquely from above;

FIG. 4b is a bottom, elevational view of the chambered doctor blade shown in FIG. 2, viewed obliquely from below;

FIG. 5 is a side, partly exploded, perspective view of the chambered doctor blade shown in FIG. 2, viewed from the side opposite the roller;

FIG. 6 is a side, perspective view of the chambered doctor blade shown in FIG. 2, viewed from the side opposite the roller;

FIG. 7a is a side, perspective view 6f a spray nozzle for supplying of liquid between the sealing parts of the sealing means of the present invention;

FIG. 7b is a side perspective view of the spray nozzle shown in FIG. 7a;

FIG. 8a is a front plane view of a rotating spray nozzle for cleaning of chamber of the present invention;

FIG. 8b is a side, elevational, cross-sectional view of the spray nozzle shown in FIG. 8a;

FIG. 8c is a side, elevational, cross-sectional exploded view of the spray nozzle shown in FIG. 8a;

FIG. 8d is a side, perspective, exploded view of the nozzle shown in FIG. 8a; and

FIG. 8e is a side, perspective view of the spray nozzle shown in FIG. 8a.

### DETAILED DESCRIPTION OF THE INVENTION

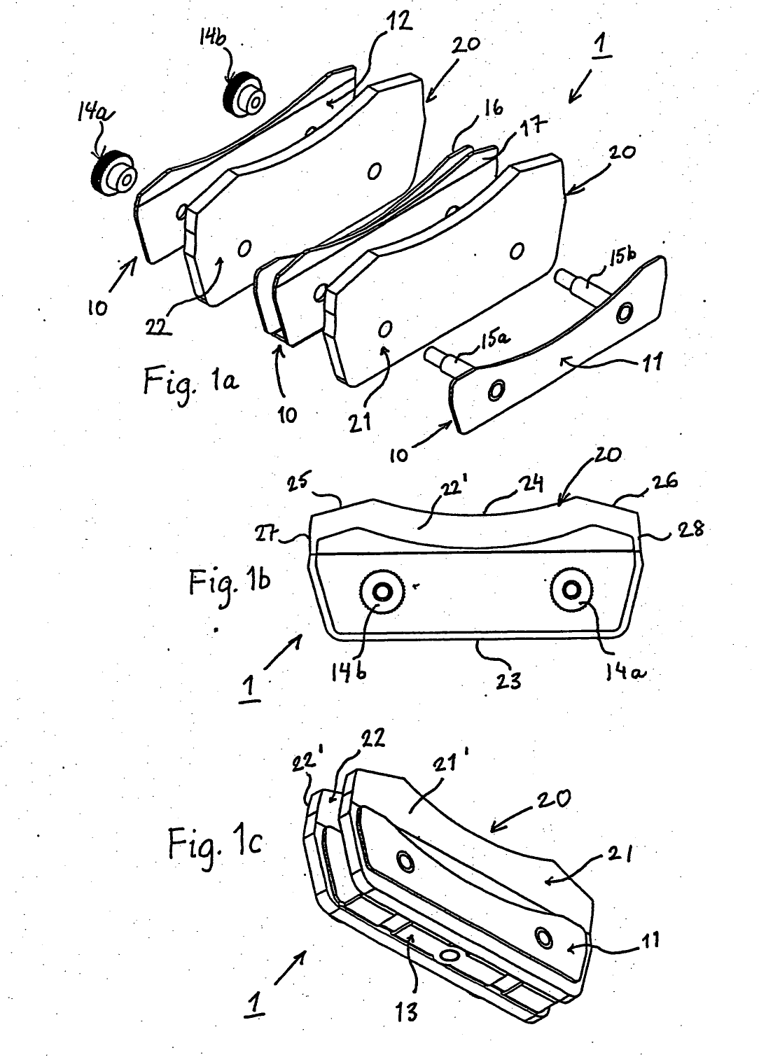

Referring to the figures, FIGS. 1a-1c show sealing arrangement 1 according to a preferred embodiment of the present invention. The sealing arrangement 1 comprises holding means 10 and sealing means 20, which means comprises a first sealing plate 21 and a second sealing plate 22. The holding means 10 comprises first and second holding elements, 11 and 12, and a spreader 13, which are held together by tightening means, 14a, 14b, 15a, and 15b, which preferably consist of nuts, 14a and 14b, and screws, 15a and 15b. The spreader 13 of the holding means 10 includes third and fourth holding elements, 16 and 17, which are mutually parallel and connected at a distance from each other in such a way that a space is formed therebetween.

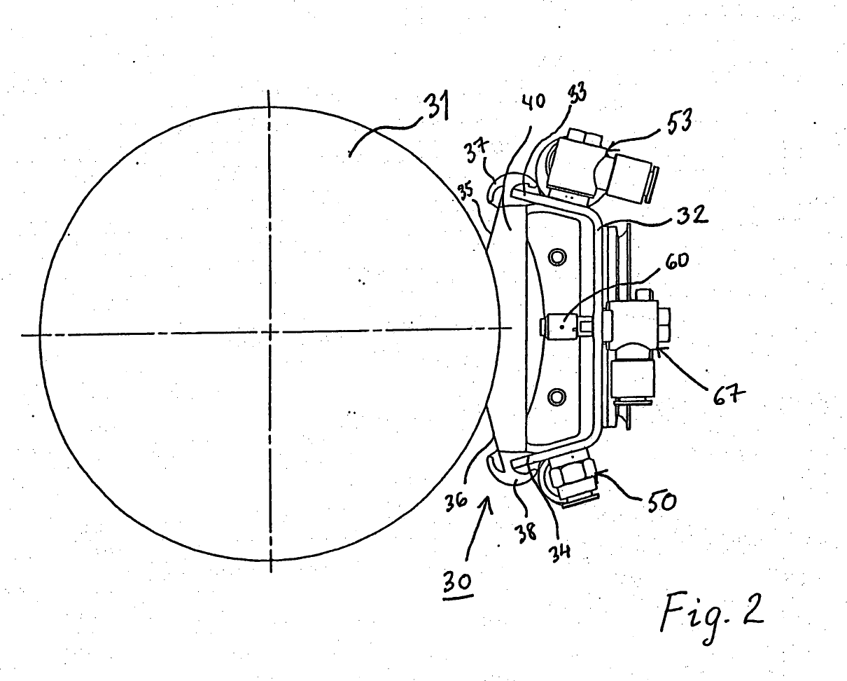

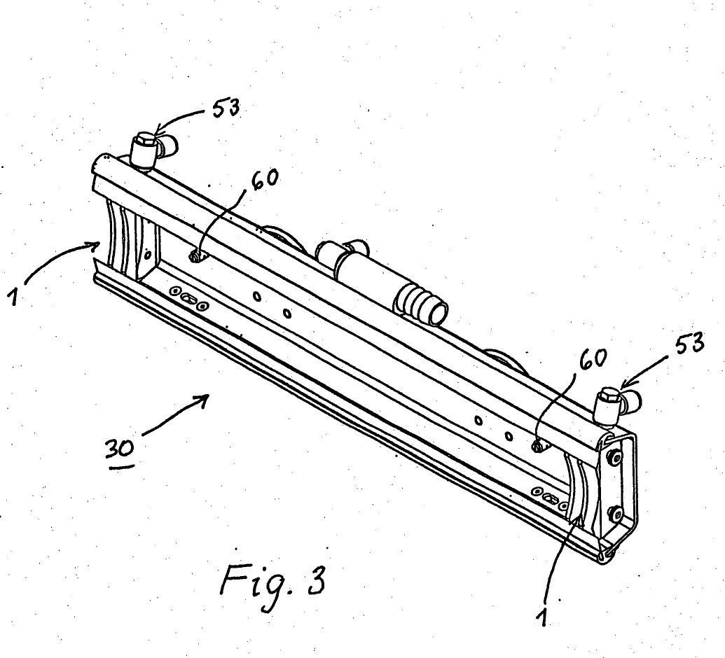

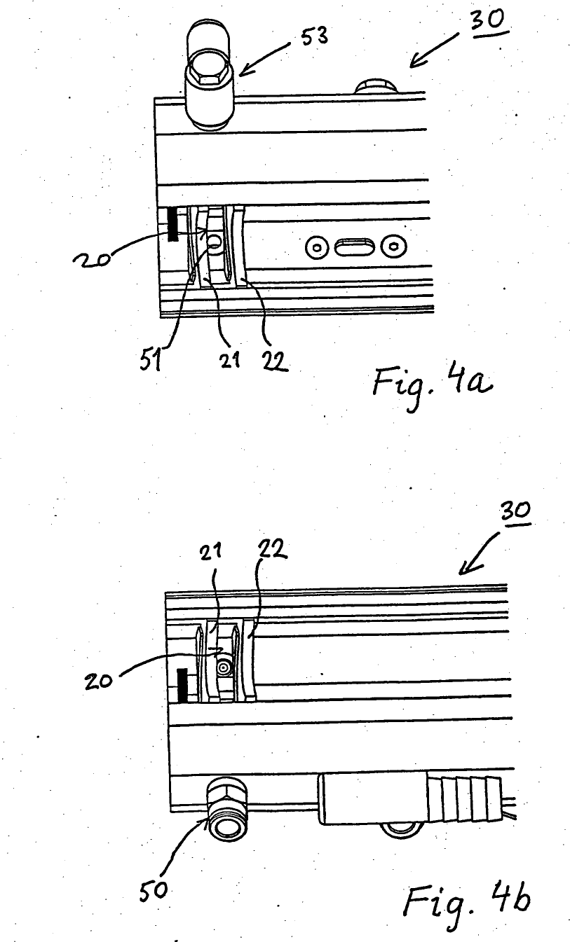

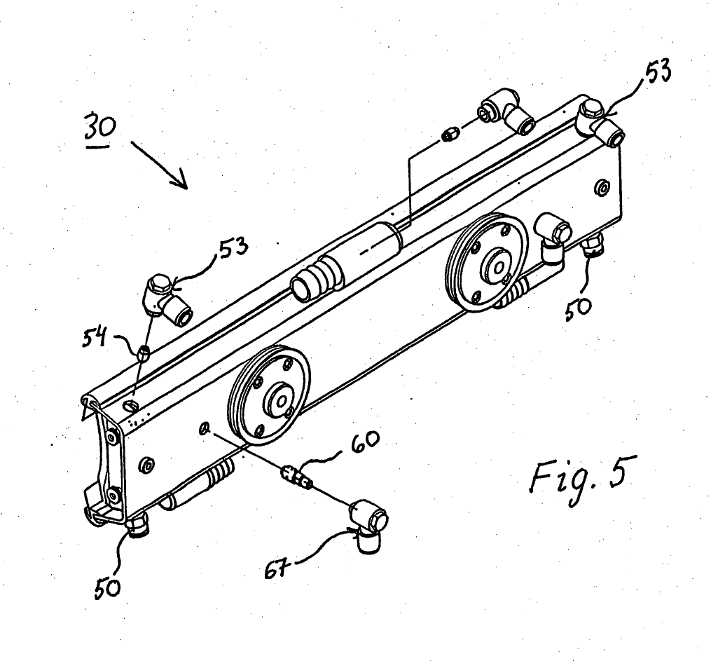

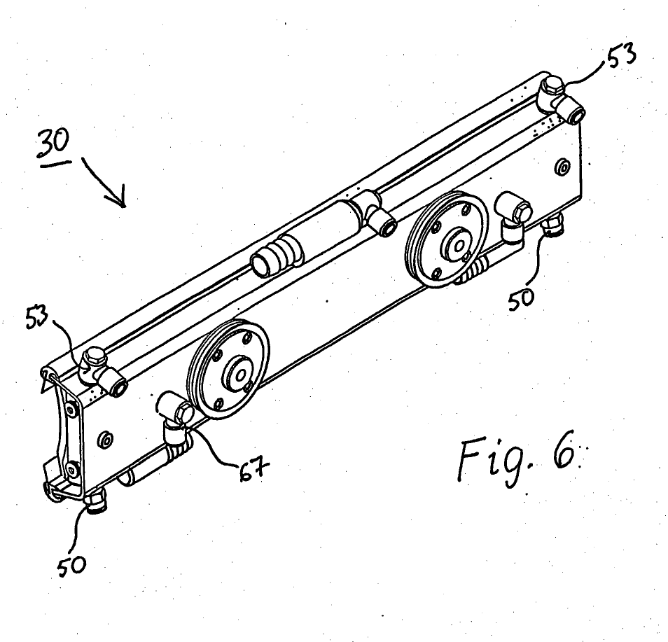

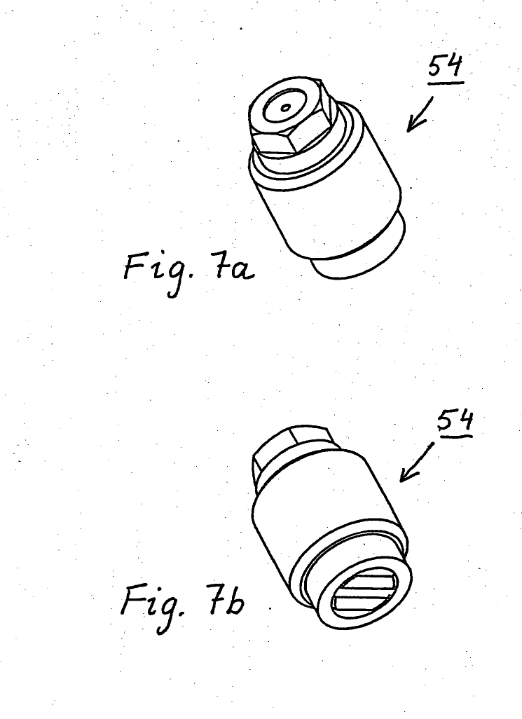

The sealing arrangement 1 is intended for sealing printing units with a chambered doctor blade device 30, which is shown in FIGS. 2-6. As can be seen in FIGS. 4a and 4b the sealing arrangement 1 is placed at the end of an elongated chambered doctor blade 30, which is arranged in a printing unit including rotatable roller 31 such that its longitudinal axis is parallel to the longitudinal axis of the roller. The chambered doctor blade 20 includes an elongated frame 32, having a substantially U-shaped cross section, with outwardly projecting flanges, 33 and 34, at which two elongated doctor blades, 35 and 36, are mounted by means of holding means, 37 and 38. The frame 32 and the doctor blades, 35 and 36, define a chamber 40 having a primarily trapezoidal cross section, and having a primarily trapezoidal opening at each end. The sealing arrangement 1 is intended to be mounted on the chambered doctor blade 30 at the respective opening in order to sealingly close same. The chamber 40, which may contain liquid, such as ink, lack or glue, further has a substantially rectangular opening, which is partly delimited by the doctor blades, 35 and 36. In either its operating or active position the chambered doctor blade 30 is fixed to the roller 31, the elongated substantially rectangular opening facing the envelope surface of the roller for applying, for example, ink on the envelope surface.

The holding elements, 11, 12, 16, and 17, are substantially trapezoidal. Between the third and fourth holding elements, 16 and 17, of the respective spreader 13 fasteners, 18 and 19, are arranged in the end, connecting the holding elements, 16 and 17, which fastener is intended to be fastened to the chambered doctor blade 30 substantially opposite the rectangular opening of the chamber 30. The fastener preferably consists of a screw and a nut.

As can be seen in FIGS. 1b and 1c the sealing plates, 21 and 22, outside of the holding means 10, have extending portions, 21′ and 22′, intended to be sealingly fixed against the inner side of the surrounding frame 32 chambered doctor blade 30, the doctor blade holders, 37 and 38, the doctor blades, 35 and 36, and the envelope surface of the roller between the doctor blades.

The sealing plates, 21 and 22, are preferably formed in a foamed polymer material, such as polyethylene, and are each preferably approximately 5-10 mm thick.

Further, the sealing plates, 21 and 22, in the disclosed method are substantially trapezoidal, having two opposite long sides or bases and two opposite oblique, none parallel sides, and having a circumferential edge divided into six edge portions, 23, 24, 25, 26, 27, and 28, which is apparent from FIG. 1b. The first edge portion 23 is U-shaped and includes the shorter base or long side of the trapezoid, both of its non-parallel sides, and is arranged to seal against the inside of the frame 32 of the chambered doctor blade 30. The sealing plates, 21 and 22, have an second opposite curve-shaped edge 24, which, in the operating position of the chambered doctor blade, is arranged to bear against the roller 31. Further, the third and fourth edge portions, 25 and 26, of the sealing plates, 21 and 22, corresponding to the chamfered corners of the plates, arranged to seal against each of the doctor blades 35 and 36, farthest away from the roller lying portion thereof. The fifth and sixth edge portions, 27 and 28, of the sealing plates, 21 and 22, are intended to seal against the second portion of the part of each holding means, 37 and 38, bearing against the inside of the chambered doctor blade 30 and outwardly projecting flange, 33 and 34, respectively. The respective sealing plates, 21 and 22, are provided with two holes for the screws.

As can be seen from FIGS. 2-6, through the first sealing plate 21, leaking ink is arranged to be led away through a hose connected channel 50, the inlet 51 located at the bottom of the chambered doctor blade 30, between the first and second sealing plates, 21 and 22, at the respective ends of the chambered doctor blade 30. The ink or the like may, depending on its viscosity, either flow gravimetrically through the hose or be pumped away with a small pump placed, for example, in connection with the end/ends of the chambered doctor blade 30.

In order to guarantee drainage of the leaking ink, the chamber 30 is, as also may be seen in FIGS. 2-6, also provided at the respective ends with connecting means 53 for supplying liquid to a spray nozzle 54 which is placed above the inlet 51 of the channel 50 for drainage of the ink or the like. It is intended to intermittently spray solvent through the spray nozzle into the space, between the first and second sealing plates, 21 and 22, in order to guarantee that no leaking ink or the like dries and the ink is diluted and thereby becomes more thinly liquid and may more easily flow through the drainage channel 50.

The first sealing plate 21 is arranged, when mounted to the opening of the chambered doctor blade 30, to face inwardly towards the chamber 40 containing, for example, ink. Normally the second sealing plate 22 is arranged to when mounted at the opening of the chamber to be placed right at the end of the screen roller 31. The sealing means 20 according to the present invention, due to bringing about a completely tight sealing of the chamber 40, in an alternative embodiment results in respective sealing means 20 being placed at an arbitrary distance into the trapezoidal opening of the chambered doctor blade 30. Further, printing with multiple ink colors abreast in one and the same printing unit is facilitated. This is arranged in such a way that each desired position of the sealing means in the chamber 30 has its own set of threaded holes for drainage, spray nozzle 54 and fixation. These holes are then intended to be plugged with threaded plugs when not in use. The plugs are then intended to be placed in inactive positions.

Drainage channels and spray nozzles are intended to be unscrewed and moved to the active positions, such that a minimum of channels and spray nozzles are required in order to be able to use the chamber with a maximum number of ink colors abreast.

The sealing means 20 according to the present invention, together with drainage and spray nozzles, consequently results in completely tight bulkheads between the different ink colors. Possible leaking ink from the first part 21 of the sealing means 20 is arranged to be brought back to the corresponding ink vessel according to above, with minimal loss.

The only limitation of the arrangement would be how much two adjacent sealing means build in the longitudinal axis of the chamber.

The spray nozzles 54 are also intended to effectively rinse the space between the first and second sealing plates, 21 and 22. The portion of the screen roller 31 running between first and second sealing plates, 21 and 22, are also intended to be rinsed/washed by solvent from these spray nozzles 54.

During changing of ink the chambered doctor blade 30 remains in contact with the screen roller 31, is drained on printing ink, and is rinsed out internally with suitable detergent/rinsing agent by means of special spray nozzles, 54 and 60. The entire rinsing procedure is handled by a sequence control equipment (PLC).

By more extensive cleaning and maintenance of the chamber 30, this is removed from the printing unit.

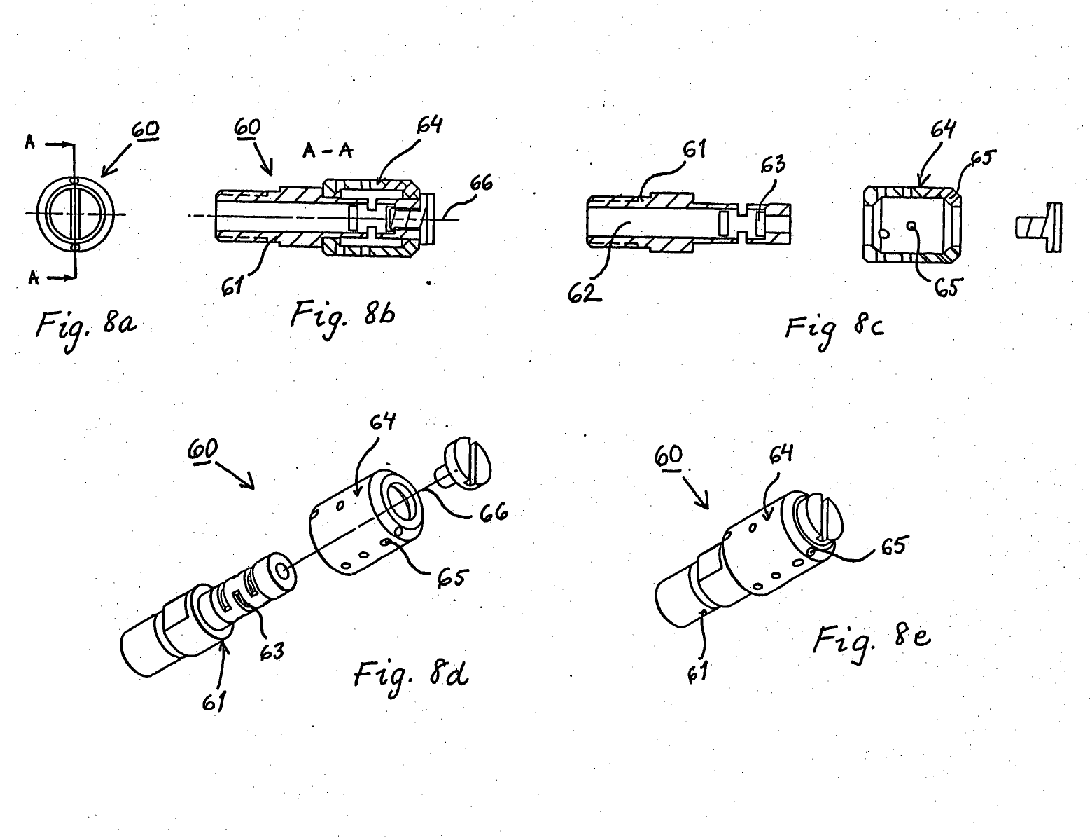

FIGS. 8a-8e show a spray nozzle 60 according to the present invention comprising a substantially tubular portion 61 comprising a supply channel 62 for liquid, which at its outlet end comprises openings 63 and at that end rotatable housing 64 having several openings 65 arranged for discharging liquid. At least some of the openings 65 in the housing run non-radially in order, by means of ejector action, to rotate the housing 64 about its own axis 66. The spray nozzles 60 are intended to clean the chamber 40 and are preferably arranged in the frame 32 of the chambered doctor blade 30 opposite the roller 31. Connecting means 67 for supplying liquid by means of a hose to the spray nozzles 60 are connected to the nozzles 60.

By using such a spray nozzle 60, rotating about its own axis 66, and thereby spraying a much larger area or section of the chambered doctor blade 30, a significantly smaller amount of spray nozzles 60 may be used with the same effect as several immobile spray nozzles. Using fewer spray nozzles means less details to maintain, simpler installation with less holes in the frame of the chamber and less hoses to draw and connect to a second pump supplying these with washing liquid. The rotating spray nozzles 60 are arranged to spray in all directions, including backwardly against the wall to which they are mounted. One single spray nozzle may cover up to half a meter of a chambered doctor blade, in contrast to a conventional spray nozzle, normally covering one to two decimeters of a chambered doctor blade.

Embodiments of spray nozzles may nevertheless be conceived of having varying outlet directions, but which are fixed, i.e. non-rotatable.

Throughout this application it is intended that a spray nozzle, is a kind of nozzle to which a hose or the like is intended to be connected and through which a liquid such as detergent or rinsing agent, is intended to be sprayed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-26. (canceled)

27. Apparatus for applying a liquid medium to a rotatable cylinder comprising a chambered doctor blade including an elongated frame disposed parallel to the outer surface of said rotatable cylinder, a pair of doctor blades operatively arranged parallel to said rotatable cylinder and parallel to and separated from each other for wiping engagement with said surface of said rotatable cylinder, sealing means disposed axially with respect to said rotatable cylinder and comprising a first sealing member and a second sealing member spaced apart from said first sealing member to form a space therebetween, said elongated frame, said pair of doctor blades, said sealing means, and said surface of said rotatable cylinder forming an elongated chamber containing said liquid medium for application to said surface of said rotatable cylinder, and at least one drainage channel including an inlet disposed in said space between said first and second sealing members for diverting leaking liquid medium from said space.

28. The apparatus of claim 27 wherein said liquid medium comprises a liquid selected from the group consisting of ink, lacquer, adhesives, and mixtures thereof.

29. The apparatus of claim 27 wherein said inlet of said at least one drainage channel is disposed in a lower portion of said elongated frame.

30. The apparatus of claim 27 including a pump connected to said at least one drainage channel for pumping out said liquid medium.

31. The apparatus of claim 27 wherein said at least one drainage channel diverts said liquid medium into a tank.

32. The apparatus of claim 27 including at least one spray nozzle disposed above said inlet of said at least one drainage channel for intermittently supplying solvent thereto for maintaining drainage and preventing drying of said liquid medium.

33. The apparatus according to claim 32 wherein said at least one spray nozzle is disposed for cleaning said elongated chamber.

34. The apparatus of claim 32 wherein said at least one spray nozzle is movable between a plurality of outlet directions.

35. The apparatus of claim 32 wherein said at least one spray nozzle is rotatable about its axis.

36. The apparatus of claim 27 wherein said sealing means comprises first sealing means, and including second sealing means including a third sealing member and a fourth sealing member spaced apart from said third sealing member for forming a second space therebetween.

37. The apparatus of claim 27 including a plurality of said sealing means provided in the axial direction of said rotatable cylinder.

38. Apparatus for supplying a liquid medium to a rotatable cylinder comprising a chambered doctor blade including an elongated frame disposed parallel to the outer surface of said rotatable cylinder, a pair of doctor blades operably arranged parallel to said rotatable cylinder and parallel to and separated from each other for wiping engagement with said rotatable cylinder, sealing means disposed axially with respect to said rotatable cylinder, said elongated frame, said pair of doctor blades, said sealing means, and said surface of said rotatable cylinder defining an elongated chamber containing said liquid medium for application to said surface of said rotatable cylinder, and at least one spray nozzle disposed within said elongated chamber for cleaning said elongated chamber, said at least one spray nozzle being movable between a plurality of outlet directions.

39. The apparatus of claim 38 wherein said at least one spray nozzle is rotatable about its axis.

40. The apparatus of claim 38 wherein said sealing means comprises a first sealing member and a second sealing member spaced apart from said first sealing member to form a space therebetween.

41. The apparatus of claim 40 including at least one drainage channel including an inlet disposed in said space between said first and second sealing members for diverting leaking liquid medium from said space.

42. The apparatus of claim 41 wherein said inlet of said at least one drainage channel is disposed in a lower portion of said elongated frame.

43. The apparatus of claim 41 including a pump connected to said at least one drainage channel for pumping out said liquid medium.

44. The apparatus of claim 41 wherein said at least one drainage channel diverts said liquid medium into a tank.

45. The apparatus of claim 38 wherein said at least one spray nozzle is disposed above said inlet of said at least one drainage channel for supplying solvent into said elongated space for maintaining drainage and preventing drying of said liquid medium.

46. The apparatus of claim 40 wherein said sealing means comprises first sealing means, and including second sealing means including a third sealing member and a fourth sealing member spaced apart from said third sealing member to form a second space therebetween.

47. The apparatus of claim 40 including a plurality of said sealing means provided in the axial direction of said rotatable cylinder.

48. A method of sealing a chambered doctor blade for use in applying a liquid medium to a rotatable cylinder wherein said chambered doctor blade includes an elongated frame disposed parallel to the outer surface of said rotatable cylinder, a pair of doctor blades operatively arranged parallel to said rotatable cylinder and parallel to and separated from each other for wiping engagement with said rotatable cylinder, and wherein said elongated frame, said pair of doctor blades, said sealing means and said surface of said rotatable cylinder define an elongated chamber containing said liquid medium for application to said rotatable cylinder, said method comprising draining said liquid medium from said elongated chamber through said sealing means.

49. The method of claim 48 including intermittently supplying solvent into said elongated chamber for preventing drying of said liquid medium and/or dissolving dried liquid medium.

50. The method of claim 48 including pumping liquid medium from said elongated chamber.

51. The method of claim 48 including diverting said liquid medium to a tank.
